(19) United States
(12) Patent Application Publication
(10) Pub. No.: US 2017/0270547 A1
(43) Pub. Date: Sep. 21, 2017

(54) Application Based Public Opinion Polling Method - a modern approach to public opinion polling

(71) Applicant: Michael Daniel Poltz, Katy, TX (US)

(72) Inventor: Michael Daniel Poltz, Katy, TX (US)

(21) Appl. No.: 15/459,245

(22) Filed: Mar. 15, 2017

Related U.S. Application Data
(60) Provisional application No. 62/310,190, filed on Mar. 18, 2016.

(51) Int. Cl. G06Q 30/02

(52) U.S. Cl. CPC G06Q 30/0203; G06Q 30/0205

(57) ABSTRACT

A method to conduct a public opinion poll via application on smart phone or electronic device is discussed. This is a survey based method of gathering public opinion data, without using the traditional method of a telephone based survey, or emerging method of deducing public opinion by internet search and preference methods tracking. The concept in this context is to propose that an application resident on a smart phone/device is utilized to poll the public without a verbal exchange with a caller. This differs from the current telephone based method of randomly calling citizens of the polling population, or web based surveys that don't employ standard polling methodology on which to base the results. The concept proposes to include a background statement putting the poll questions in context, limiting poll to three questions and three possible responses for each, and providing a countdown timer indicating time remaining before poll is ended.

### CROSS REFERENCE TO RELATED APPLICATIONS:

EFS ID 25240679

Application No. 62/310,190

Title: VOICE 99—A Modern Public Polling Application (APP) Concept and Method

Mar. 18, 2016

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND

### Field of Invention: Public Opinion Polling

The problem with current public opinion polling: Currently utilized public polling methods have not evolved in tandem with modern communication styles. As such, they increasingly suffer from low participation, where certain demographics are under or over represented. These shortcomings are contributory to the increasingly erroneous predictions and inaccurate poll outcomes.

Inaccuracy and incompatibility with current polling methods and modern society: Increasingly, public opinion polls have been spectacularly incorrect in projecting the winners or outcomes of public voting events. There are multiple recent examples to choose from, and some of summarized in the article below.
According to Joseph P Williams: Three different public-opinion polls, three important elections, three decisively erroneous results: President Barack Obama blindsided Romney in the 2012 presidential elections, winning a second term by five points; McConnell crushed Alison Lundergan Grimes en route to becoming Senate majority leader in 2014; and Scots last year overwhelmingly chose to keep ties with the United Kingdom, an outcome that stunned the polling establishment.
Once a seemingly infallible cornerstone of the political system, public opinion polls have racked up a few big-time fails in recent years, embarrassments that compelled a leading firm to conduct an internal audit to find out what went wrong.
And it matters because “polling is a very important element of democracy,” said Michael Traugott, a University of Michigan political science professor who specializes in polling and opinion surveys.
Polls “give the public an independent voice that's not generally present” otherwise in politics and political news coverage, Traugott said. But he says the recent errors, and a steep decline in the number of people responding to opinion surveys, is “a worrisome trend because one of the main claims of polling is that it represents the people's views.”
Gallup's audit, however, also says the entire industry is due for an overhaul, with some of the leading firms using analog, black-and-white methods in a digital, multicultural world. Case in point: the rise of the cell phone and the fall of public engagement in opinion surveys.
Traugott says the percentage at which people participate in opinion polls has bottomed out in the past few decades, from more than half in the 1980s to the single digits today, and most experts believe cellphone use is the reason.
Tourangeau says the technology factor likely slanted 2015 polls in Israel indicating embattled Israeli Prime Minister Benjamin Netanyahu's Likud Party was locked in a dead heat with the opposition just days before high-stakes parliamentary elections. Likud, however, won in a blowout, handing Netanyahu another term as Israel's leader and giving the polling industry another headache.
“It's not just an American problem, it's a worldwide problem,” Tourangeau says. (Williams, 2015)

Additionally, governments are increasingly influenced to implement programs by a relative minority of the population due to a poor understanding of the full support an initiative does or does not have. This can be seen with recent implementation of carbon taxing schemes in Canada, Australia and other countries, for example.

Very vocal social minority groups can dominate a public conversation that lacks participation from the overwhelming majority of the population. One of the reasons low participation or vocalization of opinion by the majority is becoming a prevalent problem in western societies is because most residents are not inconvenienced or pained by a particular situation to become informed or invested in the public consultation until a change has been implemented, at which time they start to comprehend the impacts and get involved in actively lobbying for a change.

Another possible reason for lack of public participation in sensitive or potentially sensitive topics is fear of reprisals or being branded.
According to ChangingMinds.org, Minority Influence: Many people in majorities are only there because they do not hold strong views and are generally conservative in nature and are willing to flex their views to fit in with others. This accepting position also makes them vulnerable to influence and, when faced with a strongly-held minority view, they may be shocked into considering the arguments.
According to Saul McLeod: Since majorities are often unconcerned about what minorities think about them, minority influence is rarely based on normative social influence. Instead, it is usually based on informational social influence—providing the majority with new ideas, new information which leads them to re-examine their views. In this respect, minority influence involves private acceptance (i.e. internalization)—converting the majority by convincing them that the minority's views are right. (McLeod, 2007)

Programs of any nature that are implemented on a large scale and later repealed due to the awakening of the unrepresented portion of the population cost billions of dollars in resources and time that can many governments cannot afford. The cost of repealing the Obamacare program for example, could top $350 billion according Tami Luhby writing for money.cnn.com. (Luhby, 2017)

The impact of such changes are difficult to calculate on a social scale, but ineffective social policy has global and lasting consequences. Consider recent European Union approach to mass migration for example.

### REFERENCES

Drew Desilver, S. K. (2015). The challenges of polling when fewer people are available to be polled. Retrieved from PewResearchCenter: http://www.pewresearch.org/fact-tank/2015/07/21/the-challenges-of-polling-when-fewer-people-are-available-to-be-polled/Keith
Hampton, L. R. (2014). Social Media and the ‘Spiral of Silence’. Retrieved from PewResearchCenter-Internet, Science & Tech: http://www.pewinternet.org/2014/08/26/social-media-and-the-spiral-of-silence/
Luhby, T. (2017 Jan. 4). Fully Repealing Obamacare Will Cost $350 Billion. Retrieved from CNN Money: http://money.cnn.com/2017/01/04/news/economy/obamacare-repeal-deficit/index.html
McLeod, S. (2007). Moscovici and Minotiry Influence. Retrieved from SimplyPsychology: http://www.simplypsychology.org/minority-influence.html
Minority Influence. (n.d.). Retrieved from changingminds.org: http://changingminds.org/explanations/theories/minority_influence.htm
Williams, J. P. (2015 Sep. 28). The Problem With Polls. USNews.

### BRIEF SUMMARY

A method to conduct a public opinion poll via application on smart phone or electronic device is discussed. An application of software-based buttons or otherwise by speaking into, tapping on a device screen, or using visual selection are provided and enable the user to express an opinion about a provided topic, or as answer to a posed question. This is a survey based method of gathering public opinion data, without using the traditional method of a telephone based survey, or emerging method of deducing public opinion by internet search and preference methods tracking.

The concept in this context is to propose that an application resident on a smart phone/device is utilized to poll the public without a verbal exchange with a caller. This differs from the current method of either exit polling or utilizing the old fashioned telephone method of randomly calling citizens of the polling population.

Existing methods describe polling initiated by the public, or use other means and media. This application is unique as it aims to facilitate public opinion polls in a modern medium, providing all polling information on one screen. This includes a background statement putting the poll questions in context, limiting poll to three questions and three possible responses for each, and providing a countdown timer indicating time remaining before poll is ended. It further differentiates by utilizing user data to place user in the demographic for the geographical or geopolitical area while protecting their anonymity. This data is then utilized to apply a modified simple random sampling method from the user base, helping to provide accurate results. Utilizing geographical or geopolitical boundaries further enables population sampling and result tabulation on very region specific topics, or to extrapolate region specific views. And finally each poll has a limited run time window, 48 hours for example, facilitating quick response and tabulation turnaround for publication. Results are fed back to the user on their device, showing where their responses fit in the overall poll data.

The new method of public opinion polling described would provide better response rates by reaching people in a familiar and comfortable medium. Estimates show that approximately 80% of the US population today has a smart phone, well in excess of estimates in the past few years.

Even people over 65 are increasingly choosing smart phones over regular mobile devices. These numbers are mirrored in other major economies globally, and indicators show a sharp increase in the developing world. Additionally some demographic groups lack any other means of internet access, and rely solely on their smart phone, and in 2015 this was the case for 15% of Americans, according to PEW Research Center. Younger generations have abandoned traditional means of communication, and are looking for meaningful ways to engage with society, but on their terms: nonverbal, contextual, fast.

In modern society, people would rather:
a. provide their opinions anonymously for fear of backlash, challenge or ridicule
b. provide their opinions without talking to another person they don't know on the phone
c. complete an opinion poll at their convenience, not at the convenience of the caller
d. have immediate insight into where their opinions ley as compared to others

A traditional polling method is not compatible with these requirements. As a result, there has been a dramatic and steady decline in the response rates to recent polls, and this drop has severely affected their accuracy.
Cliff Zukin, past president of the American Association for Public Opinion Research and a Rutgers University political science professor, wrote recently that “two trends are driving the increasing unreliability of election and other polling in the United States: the growth of cellphones and the decline in people willing to answer surveys.” (Drew Desilver, 2015)

Additionally, poll respondents do not currently have the ability to find out in real or near real time where their opinions fit in among the rest of the population. Individuals are many times more likely to share their opinions on social media or in person if they feel that their opinion is shared widely among their audience.
Pew research indicates “In both offline and online settings, people said they were more willing to share their views . . . if they thought their audience agreed with them.” (Keith Hampton, 2014)

Results often are gathered in a matter of days or weeks and ultimately published in obscure means. An application that provides feedback of the respondent's opinion among their peers has attractive merit to users, which encourages repeat usage in subsequent polls when prompted. Quickly sharing the popularity of certain opinions is likely to encourage further participation.

The proposed application enables the user to share their opinion anonymously, encouraging minority or unpopular opinions to be expressed, and popular opinions to be clearly represented. This aids in polling accuracy greatly. Additionally, no voice or human contact is made during the polling, which increases response rates among individuals in modern society who find this type of interpersonal interaction difficult. Poll responses on the application can also be done at the user's convenience, again increasing response rates.

By asking sensitive questions in an anonymous and safe environment, in effect replicating a political voting scenario or census, the application gets a much more truthful answer, from more respondents. Overall this technique assures high response rates compared to traditional polling means, and thus greater accuracy.

Carefully crafted questions are posed during the anonymous account setup that place the user in the demographic context, geographic and geopolitical location. This is later utilized to extrapolate the full population result.

Opinion poll questions are limited to three questions on one viewable page on the device, with only three possible answers to choose from for each question. The questions are displayed in a predetermined language of choice for the user (where appropriate) and written to the degree that the average respondent's education level within the sampling pool assures adequate comprehension.

A countdown clock on the application screen shows the time remaining allotted for the poll. This has the added psychological effect of soliciting participation and adding a sense of urgency to the response.

The advantage of this type of polling method is that it reaches a much greater sampling pool. Current surveys struggle to get 1500 respondents, and then extrapolate those responses to a population of hundreds of millions. Even when using the simple random sample method, the representative population is insignificant. Pulling on a vast user base enables an approximation of the simple random sampling method but with much greater participation rates.

Recent polling errors indicate that when a population is closely divided on a particular topic (within a percentage point or two for instance), the victor and loser of a federal election for example, is difficult to predict. Having a response pool of hundreds of thousands or even millions of users increases the accuracy and confidence of the polling result.

### BRIEF DESCRIPTION OF DRAWINGS

The multiple drawings supplied refer to how the invention would function, and help demonstrate the flow of information between the survey initiator and various client devices.

FIG. 1: This graphic shows the connection between the server (#20) via the network (#10) (internet and cellular data network) to the multiple client devices depicted (#30A, 30B, 30C, 30D, 30E). Only five client devices depicted for scale, with the understanding that this connection between server and client devices is to support as many client devices as are registered to participate in the given poll for the geographic or geopolitical region.

FIG. 2: A simplified diagram depicting the direct connection between the server (#20) via network (#10) to a representative client device (#30A). The server is configured to display data on one screen of the client device, here depicting the various elements.

FIG. 3: An expanded diagram of the network (#10) connecting the server (#20) with multiple devices utilizing the application. Client Device A (#30A) is shown in detail, with the understanding that the same display is generated on each subsequent connected device, including Client Device B (#30B), Client Device C (#30C) and an infinite number of other participating client devices depicted (#31A).

FIG. 4: An expanded view of the application screen configuration on a representative client device (#30A). Sample poll display configuration is represented including contextual reference for poll questions (#100A), first opinion poll question (#110A), second opinion poll question (#120A), third opinion poll question (#130A) and countdown timer (#140A) showing remaining timeframe to submit the poll answers via the application.

FIG. 5: Depiction of possible pictographs or emoticons (#150) utilized to clearly identify response to the poll question by the client on representative client device (#30A). Affirmative selection graphics are always shown on the far left hand side of the display immediately after each question. Possible Affirmative Response graphics, clearly identifiable visually by any user are represented in Column A (#151), neutral or “no opinion” graphics are always the middle choice and represented in Column B (#152), negative or “disagree” graphics are always displayed on the far right side and are represented in Column C (#153).

FIG. 6: A depiction of client selection data from infinite devices (#200) and how it is transferred via the network (#10) to the software server (#20). The data is processed and computed to generate a poll result, depicted using a representative graph for visualization purposes (#220).

FIG. 7: This graphic shows the return of post calculation poll data (#220) via the connection between the server (#20) via the network (#10) (internet and cellular data network) to the multiple client devices depicted (#30A, 30B, 30C) and depiction of infinite devices connected via the application (#31A). Understanding that this connection between server and client devices is to support as many client devices as have installed the application, and are represented in the region defined in the poll parameters.

FIG. 8: A representative client device (#30A) showing a mockup of the returned data (#250) displayed on the client device screen. The data is represented clearly showing the respondent (client) response with relation to the questions posed in the context of replies received currently from the polled population, and extrapolated to the region.

FIG. 9: In reference to geographic or geopolitical placement, the graphic represents a sample regional outline (#400) showing the location of client devices that would be eligible for a public opinion poll using geographic or geopolitical restrictions, in this case represented by devices within the outline (Client Device A-D—#30A, #30B, #30C, #30D) with eligible devices marked by a green checkmark (#420) for demonstration and client devices outside of the outline restricted from participating in the poll with this limitation (Client Device E-G, #30E, #30F, #30G) with ineligible devices marked by a red X for demonstration (#410).

FIG. 10: A process flow representative of the steps undertaken from initiation through expiry of the time limitation for the public opinion poll. The process flow commences with the initiation of the poll (#500), context data and questions are defined (#510), geographic or geopolitical area is defined (#520), user eligibility is defined and eligible users are identified (#525), Public Opinion Poll (POP) is sent to client devices (#530), public opinion poll time window is established and countdown started as public opinion poll is initiated (#540), user answers poll questions using application (#550), data is returned to server for processing (#555), poll answers are aggregated and calculations made to extrapolate regional response (#560), data is relayed back to the client device for display (#565), response data can be shared among users or the public (#570), public opinion poll is closed when time window runs out (#590) and the results are tabulated and published.

FIG. 11: A process flow representative of the client experience including the account setup phase through to the end of the poll participation process. Flow commences with the setup of the client account in the application (#600), application asks questions to place user in demographic context (#610), application asks questions to place the user in the geographic or geopolitical context (#615), user account is activated (#620), upon creation of a poll as described in FIG. 10, user is selected for polls for the appropriate region (#630), poll data is pushed to the application on the client device (#635), poll questions and context data are displayed on client device in application (#640), answers are submitted via application (#650), results are received back on the user application showing current poll results (#565), user has opportunity to share results (#570), public opinion poll is closed when time window runs out (#590) and the results are tabulated and published.

### DETAILED DESCRIPTION OF INVENTION

A method to conduct a public opinion poll via application on smart phone or electronic device is discussed. An application of software-based buttons or otherwise by speaking into, tapping on a device screen, or using visual selection are provided and enable the user to express an opinion about a provided topic, or as answer to a posed question. This is a survey based method of gathering public opinion data, without using the traditional method of a telephone based survey, or emerging method of deducing public opinion by internet search and preference methods tracking.

The concept in this context is to propose that an application resident on a smart phone/device is utilized to poll the public without a verbal exchange with a caller. This differs from the current method of either exit polling or utilizing the old fashioned telephone method of randomly calling citizens of the polling population.

Existing methods describe polling initiated by the public, or use other means and media. This application is unique as it aims to facilitate public opinion polls in a modern medium, providing all polling information on one screen. This includes a background statement putting the poll questions in context, limiting poll to three questions and three possible responses for each, and providing a countdown timer indicating time remaining before poll is ended. It further differentiates by utilizing user data to place user in the demographic for the geographical or geopolitical area while protecting their anonymity. This data is then utilized to apply a modified simple random sampling method from the user base, helping to provide accurate results. Utilizing geographical or geopolitical boundaries further enables population sampling and result tabulation on very region specific topics, or to extrapolate region specific views. And finally each poll using this method has a limited run time window, 48 hours for example, facilitating quick response and tabulation turnaround for publication. The poll time window is displayed on the application running on the client device, showing a countdown of the time remaining. Results of the public opinion poll are fed back to the user on their device, showing where their responses fit in the overall poll data.

The new method of public opinion polling described would provide better response rates by reaching people in a familiar and comfortable medium, and by reaching others in the population that don't have access to land line telephones within the household, or computer based internet access within the household. Providing an accessible and anonymous medium shared by most people alive today, ensures high and accurate response rates not achievable with currently utilized public opinion polling techniques.

Results often are gathered in a matter of days or weeks and ultimately published in obscure means. An application that provides feedback of the respondent's opinion among their peers has attractive merit to users, which encourages repeat usage in subsequent polls when prompted. Quickly sharing the popularity of certain opinions is likely to encourage further participation.

The proposed application enables the user to share their opinion anonymously, encouraging minority or unpopular opinions to be expressed, and popular opinions to be clearly represented. This aids in polling accuracy greatly. Additionally, no voice or human contact is made during the polling, which increases response rates among individuals in modern society who find this type of interpersonal interaction difficult. Poll responses on the application can also be done at the user's convenience, again increasing response rates.

By asking sensitive questions in an anonymous and safe environment, in effect replicating a political voting scenario or census, the application gets a much more truthful answer, from more respondents. Overall this technique assures hiagh response rates compared to traditional polling means, and thus greater accuracy.

Carefully crafted questions are posed during the anonymous account setup that place the user in the demographic context, geographic and geopolitical location. This is later utilized to extrapolate the full population result.

Public opinion poll questions are limited to three questions on one viewable page on the device, with only three possible answers to choose from for each question. The questions are displayed in a predetermined language of choice for the user (where appropriate) and written to the degree that the average respondent's education level within the sampling pool assures adequate comprehension.

A countdown clock on the application screen shows the time remaining allotted for the poll. This has the added psychological effect of soliciting participation and adding a sense of urgency to the response.

The advantage of this type of polling method is that it reaches a much greater sampling pool. Current surveys struggle to get 1500 respondents, and then extrapolate those responses to a population of hundreds of millions. Even when using the simple random sample method, the representative population is insignificant. Pulling on a vast user base enables an approximation of the simple random sampling method but with much greater participation rates.

Recent polling errors indicate that when a population is closely divided on a particular topic (within a percentage point or two for instance), the victor and loser of a federal election for example, is difficult to predict. Having a response pool of hundreds of thousands or even millions of users increases the accuracy and confidence of the polling result.

Timely and accurate feedback from the populous in any region to the government, organization or other entity seeking information benefits the population, and indeed all humanity. Clear representation of the majority opinion in any region enables governments and institutions to align their policy and strategy to the will of the majority, waste less resources moving policy in the wrong direction based on highly vocal minority opinion, and facilitate progress by building on past strategy and success over the course of multiple administrations over time.

The detailed description referencing the figures supplied gives the reader insight into the unique combination of elements and concepts represented in this application. Upon review, it should be evident that this novel combination ushers in a new method of public opinion gathering that takes into account the generational evolution of human communication, and leverages commonly available technology, to enable vast numbers of the population polled to express their opinions on important matters quickly and effectively. While some images are relatively straight forward displaying basic background communication links between application servers and client devices, others describe in detail the unique aspects of the invention, claims, displays and process. The specific details described are exemplary, and meant to outline the general concept behind each element that will allow for some variation in the actual embodiment, while remaining within the spirit of this application.

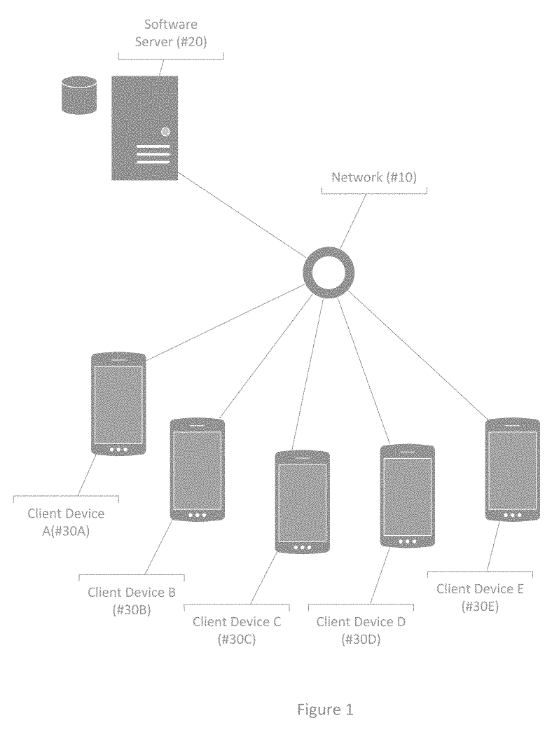

FIG. 1: This graphic shows the connection between the server (#20) via the network (#10) (internet and cellular data network) to the multiple client devices depicted (#30A, 30B, 30C, 30E). Only five client devices depicted for scale, with the understanding that this connection between server and client devices is to support as many client devices as are registered to participate in the given poll for the geographic or geopolitical region.

The server (#20) utilized to push the poll data to the client device (#30A, 30B, 30C, 30E), receive the poll answers from the client device (#30A, 30B, 30C, 30E) and perform the background calculations needed to extrapolate the population response to the questions is located remotely, and potentially cloud based. The representation in FIG. 1 is meant to simply show that the server needs to have a data connection to the multiple client devices (#30A, 30B, 30C, 30E) via a network (#10). The Network (#10) may be cellular, wifi or other common data sharing method employed at the time or place.

The client devices (#30A, 30B, 30C, 30E) are themselves not connected to each other, but rather only communicate with the server (#20) via the network (#10) described in the previous paragraph.

Only five client devices (#30A, 30B, 30C, 30E) are displayed so as not to obfuscate the purpose of the diagram, with the understanding that any number of client devices may be connected to the server (#20) via the network (#10) at any time. These unlimited devices may be participating in the same public opinion poll, or in various different public opinion polls being conducted around the world concurrently.

The connection via the network is not intended to facilitate a telephone conversation, but rather to relay data between the client device and the server for the purpose of a public opinion poll. No user is telephoned in the traditional sense for the purpose of the poll.

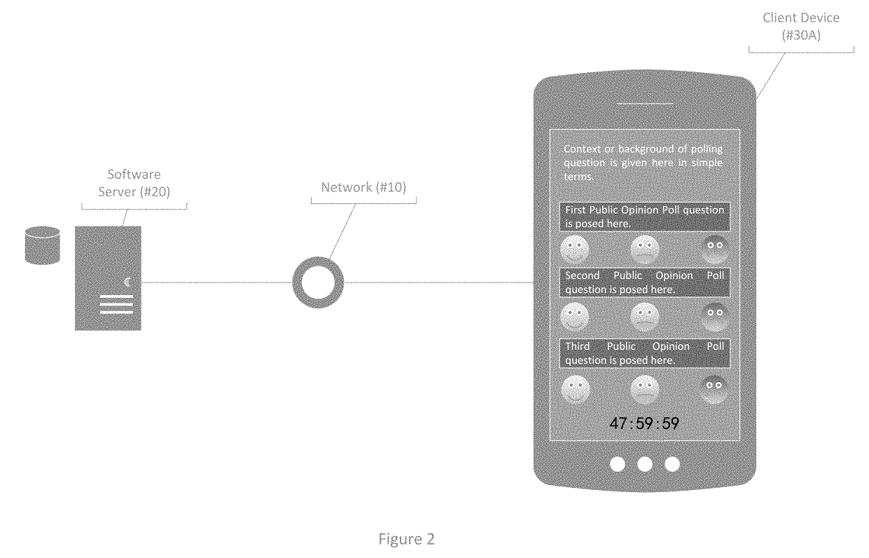

FIG. 2: A simplified diagram depicting the direct connection between the server (#20) via network (#10) to only one representative client device (#30A). The server is configured to display data on one screen of the client device, here depicting the various elements utilized to conduct the public opinion poll described.

It is understood that only one device is depicted to simplify the visualization of the connection between the server (#20) via network (#10) to only one representative client device (#30A), while unlimited such connections between various client devices and the server may exist at the same time from different locations. The Network (#10) may be cellular, wifi or other common data sharing method employed at the time or place.

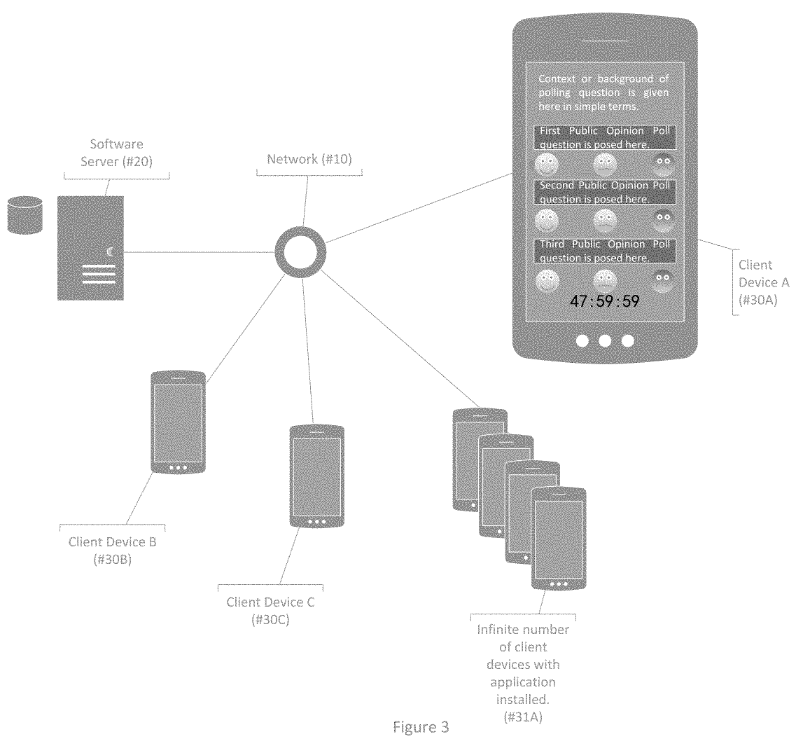

FIG. 3: An expanded diagram of the network (#10) connecting the server (#20) with multiple devices utilizing the application. Client Device A (#30A) is shown in detail, with the understanding that the same display is generated on each subsequent connected device, including Client Device B (#30B), Client Device C (#30C) and an infinite number of other participating client devices depicted (#31A).

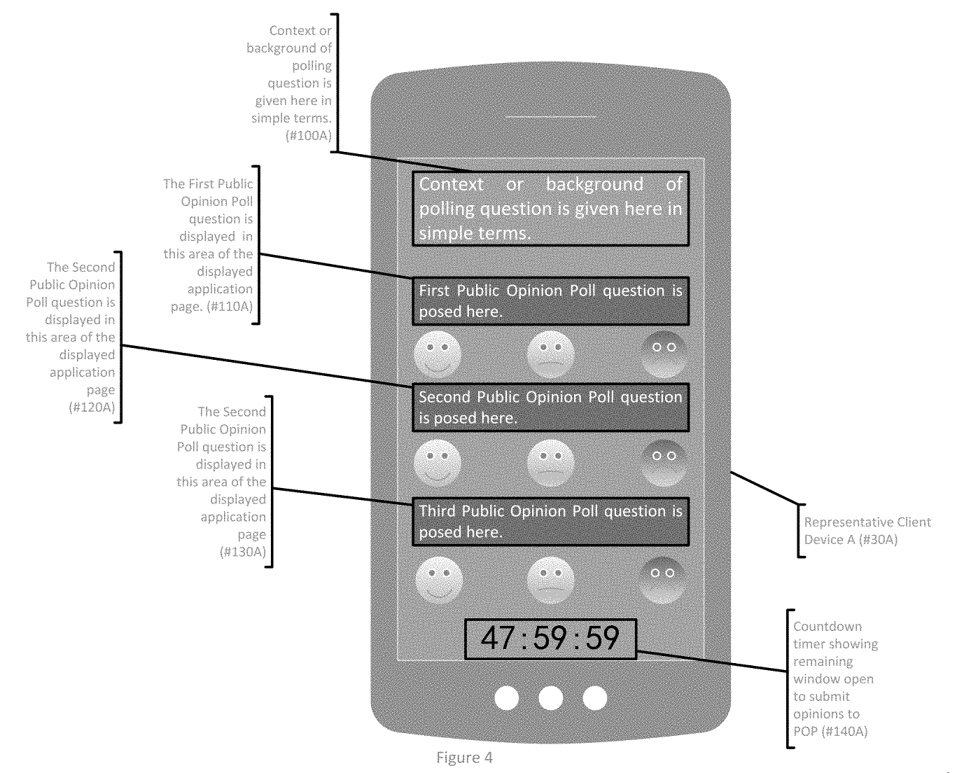

FIG. 4: An expanded view of the application screen configuration on a representative client device (#30A). While client devices may vary in size, make and manufacture, the intent of the invention is to display the same data on all of these devices in a simple and similar manner. The location of the items described in detail below is a likely format following a logical top to bottom and left to right configuration. Some adjustments may need to be made for regional language preferences, or where reading in the local language is done from top to bottom or right to left, for example, with the intent of every embodiment to remain consistent with the general spirit and tenants of this suggested layout.

Devices limited in display size, or those which text or view preferences have been enlarged to facilitate reading by the visually impaired may need to scroll through the various sections, with the understanding that they will remain on one page of the application.

Proposed poll display configuration is represented including contextual reference for poll questions (#100A), first opinion poll question (#110A), second opinion poll question (#120A), third opinion poll question (#130A) and countdown timer (#140A) showing remaining timeframe to submit the poll answers via the application. While the text in each box is used as a placeholder for the actual public opinion poll question, it is the intent of the inventor to limit the text within each box to the absolute minimum to pose the question clearly and accurately without clouding the meaning or context of the question.

The contextual reference for poll questions (#100A) is a critical attribute for the invention. As the public opinion poll questions may vary in topic, from political, commercial, social and other, it is the intent to objectively place these questions within a cognitive reference for the respondent (user), regardless of their familiarity with the deep intricacies of the topic. To facilitate both the need for short and concise contextual statements and the appropriate level of familiarity with the background of the question posed to give the respondent the most advantage in giving a true opinion on the matter, it may be necessary in some more complex public opinion poll topics to enable the user to access an online library or existing work on the topic that can be referenced. In that case, by tapping on the contextual reference box (in this instance acting as a software-based button), using a stylus for the same purpose, or otherwise by speaking into (if device is configured adequately) or using visual selection (if the device is configured and equipped adequately) the user will be linked to a reference library including published works or websites that fairly represent both sides of the issue, to enable them to make an informed decision on the following three public opinion poll questions.

The three questions (#110A, 120A, 130A) shown on the image are phrased in simple to understand language and syntax to facilitate the user of the application to accurately form an opinion in support or in objection to the statement, with a third option reserved for no opinion or to withhold opinion. The composition of each question will take into account the local population average education and comprehension level, and strive to meet the objective of the poll, while phrasing the statement in such a way as the average respondent has a good chance of understanding the meaning of the question, and of forming or expressing their opinion on the topic. The intent is to limit the question wording for each question, to the minimum text necessary to meet the objectives without confusing the respondent by not supplying enough information.

The countdown timer (#140A) is displayed on the screen showing the time remaining for the poll. By providing a countdown, the window for the public opinion poll is shown to the user. The purpose of clearly showing the time remaining is the help facilitate participation in the poll by creating a sense of urgency. The countdown timer (#140A) is currently shown at the bottom of the application poll question space, but may be placed in a more prominent position, at the top for example, following some user testing to determine the optimal position to meet the objectives of the component (#140A) within the context of the application as a whole. In this embodiment the countdown timer (#140A) is shown as a numeric display in the HH:MM:SS (H: Hour, M: Minute, S: Second) format. It is understood however that the format in this case is representative of the concept of displaying time remaining rather than limiting the options of display for the timer. For instance, an analog clock, or other graphic showing the time remaining may be utilized to the same end, and may prove to be more effective following user testing. The time remaining displayed in the image is 47:59:59, which could represent a snapshot of one second under a 48 hour time window. It is not the intent of this application to limit the time to 48 hours, as a shorter or longer duration may better serve the purpose of the public opinion poll. Rather, it is the intent to include a countdown timer in some fashion as described in this detailed explanation of the image as a critical component of the claims made further.

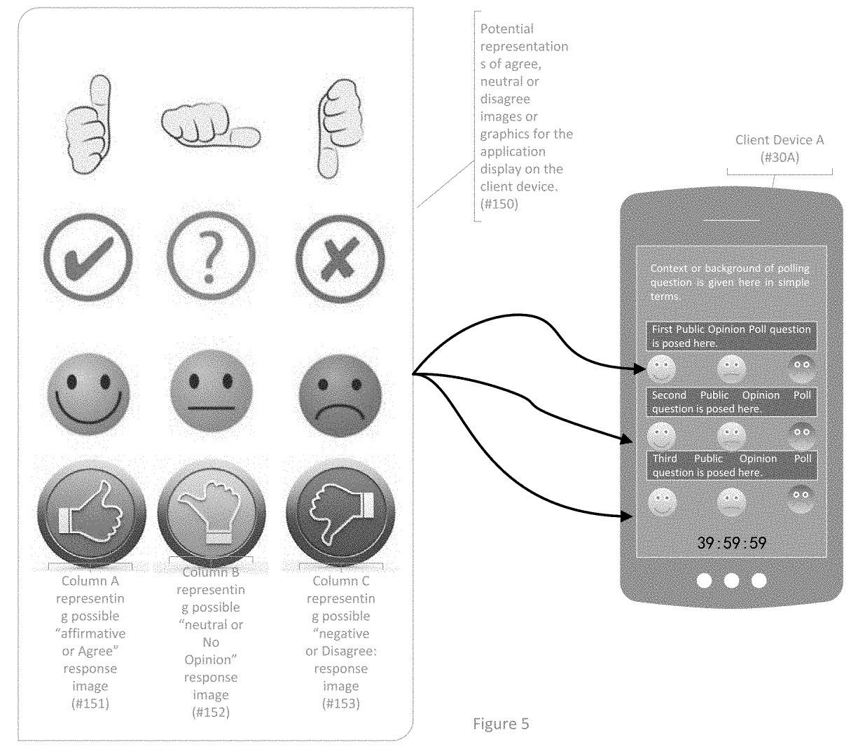

FIG. 5: Depiction of possible pictographs or emoticons (#150) utilized to clearly identify response to the poll question by the client on representative client device (#30A). Affirmative selection graphics are shown on the far left hand side of the display immediately after each question. Possible Affirmative Response pictographs or emoticons, clearly identifiably visually by any user are represented in Column A (#151), neutral or “no opinion” pictographs or emoticons are always the middle choice and represented in Column B (#152), negative or “disagree” pictographs or emoticons are displayed on the far right side and are represented in Column C (#153).

The pictographs or emoticons utilized below each question flow from the affirmative on the left, neutral in the middle to negative on the far right. The combination is to remain static, with the understanding as stated previously that it may need to be adjusted for regional applications where the population base reads from right to left, and the application is translated to a local language.

Users of the application on the client device will make a selection of their preference in answer to each posed question by tapping on the software-based buttons represented by the pictograph or emoticon that matches their answer, using a stylus for the same purpose, or otherwise by speaking into (if device is configured adequately) or using visual selection (if the device is configured and equipped adequately).

The images, pictographs or emoticons utilized to represent possible affirmative, no opinion, or negative responses are not necessarily limited to those displayed in Column A (#151), Column B (#152) and Column C (#153). The images, pictographs or emoticons proposed for the purpose of explanation are intended to be globally recognizable and associated to the universal affirmative, no opinion and negative responses. These are here represented as a hand signal for thumbs up, neutral or down; a green checkmark, blue question mark, or red “X”; green smiley face, blue neutral face, or red sad face; or the previously mentioned thumbs displays combined with a color background to be further intuitive.

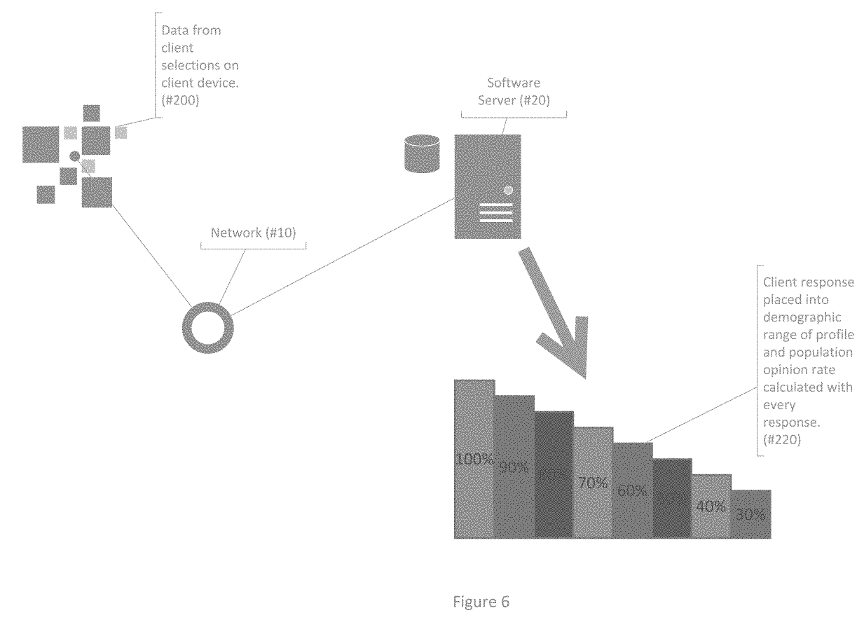

FIG. 6: A depiction of client selection data from infinite devices (#200) and how it is transferred via the network (#20) to the software server (#20). The data is processed and computed to generate a poll result, depicted using a representative graph for visualization purposes (#220).

Users will respond to the public opinion poll as previously described. These responses, from all user devices, will be sent back to the application server for computation. Using calculations outside the scope of this application, based on current practice in the art, the data will be extrapolated to reflect the overall population opinion, and may include other details related to the demographic character of the user participating in the poll that have relevance. The data will be aggregated for the purpose of analysis, over the course of the public opinion poll time window. The intent of this diagram is to show the continued connection between the user devices and the server (#20) during the public opinion poll to facilitate the transfer of data related to the poll.

The data may be represented in numerous ways, including graphical or written content, in this embodiment by a representative graph for visualization purposes (#220), and indeed may be visualized for the users of the application, and written in a more detailed analysis for other explanatory, educational, analytical or commercial purposes.

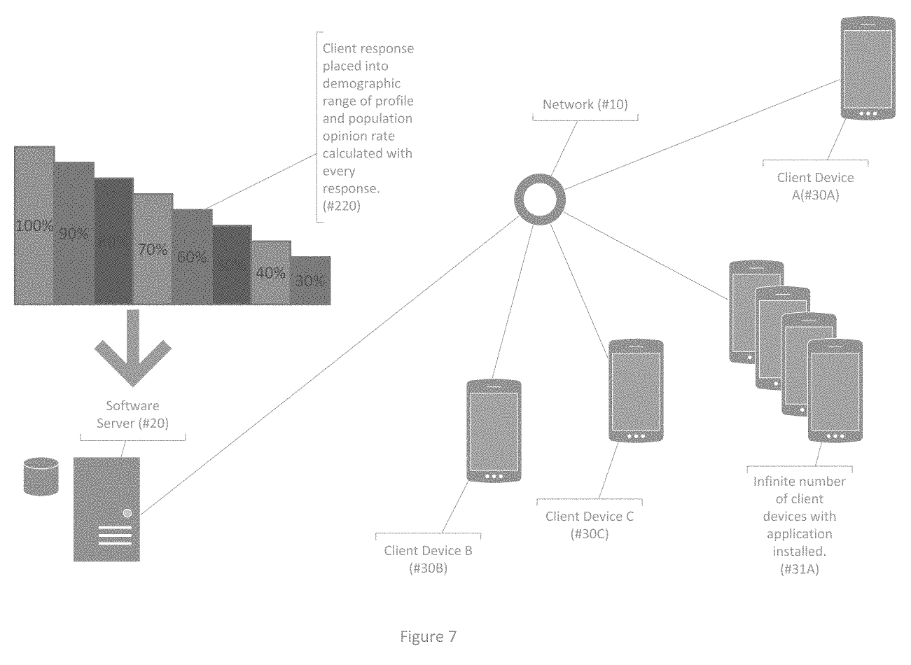

FIG. 7: This graphic shows the return of post calculation poll data between the server (#20) via the network (#10) (internet and cellular data network) to the multiple client devices depicted (#30A, 30B, 30C) and depiction of infinite devices using the application (#31A). Understanding that this connection between server and client devices is to support as many client devices as have installed the application, and are represented in the region defined in the poll parameters.

As user response data is received, calculations will be made and current public opinion poll data on the application server (#20) and will be relayed back to the user on the client device (#30A, 30B, 30C) via the network (#10) for display on the client device. It is understood that this data is not complete and final until the public opinion poll window has closed, and thus further updates will be made to application client devices when the application is open, opened, or refreshed or otherwise interacted with. Interim poll results may be shared with all users of the application during the poll window, regardless of their participation.

Users of this application would have unprecedented access to ongoing poll results as the polling continues, and additional new responses are integrated into the results via the application. This would help facilitate discussion and sharing of the poll results in progress among the population base, and may drive additional participation from potential users who support or disagree with the prevailing result. The intent of the invention is to drive high rates of user participation to garner more accurate results, and this unique element of the invention helps to facilitate high response rates, and clearly differentiates from other claims related to public opinion polling.

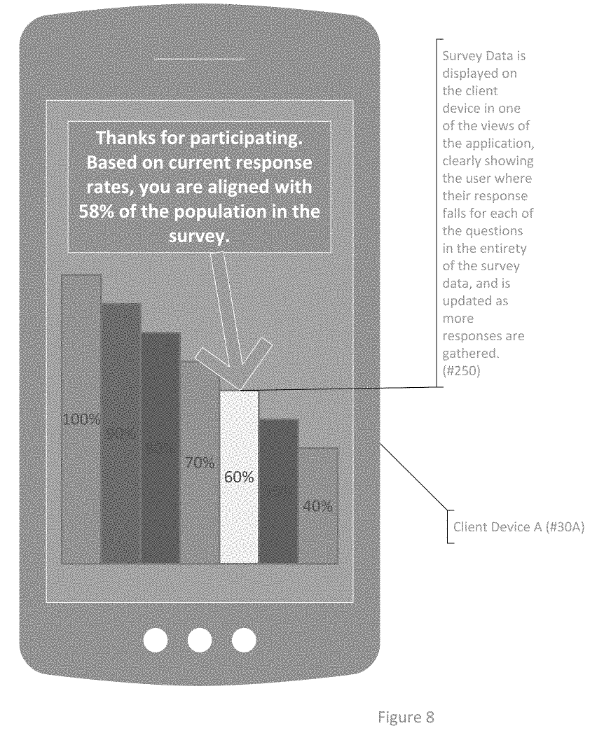

FIG. 8: A representative client device (#30A) showing a mockup of the returned data (#250) displayed on the client device screen. The data is represented clearly showing the respondent (client) response with relation to the questions posed in the context of replies received currently from the polled population, and extrapolated to the region.

Final public opinion poll results will also be indicated and pushed out to all client devices regardless of their participation, and it is understood that this may be in the form of a graphical result (#220) in a manner that accurately describes the overall population opinion on the posed poll topics, but may also give users access to a deeper analysis and material should they choose to review it. The intent is to outline the two way communication between users of the application on their client devices and the application server during the course of the public opinion poll, it is equally important to highlight the intent to share with the user their particular demographics and response rates within those demographics as compared to their own response during and after the poll.

For instance, a key feature of this application is to help the user express their opinion on important topics anonymously, but also to help them understand where their opinions fit in the overall population. This information may be displayed via several graphs relayed back to the client device, by written analysis, or a combination of both.

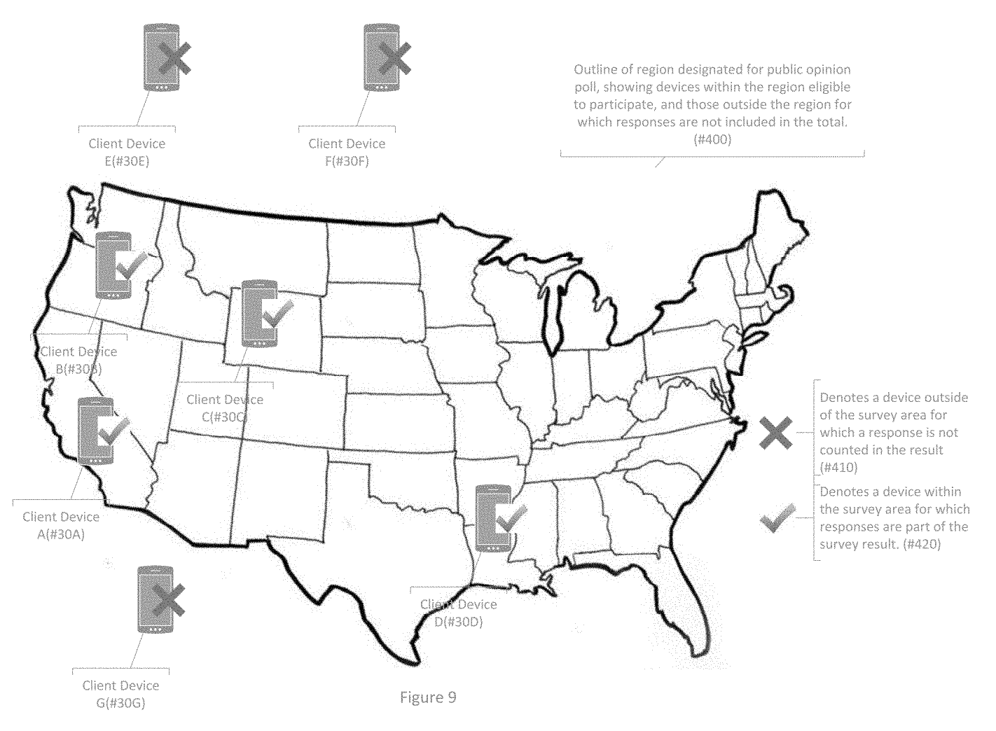

FIG. 9: In reference to geographic or geopolitical boundaries for the public opinion poll, the graphic represents a sample regional outline (#400) showing the location of client devices that would be eligible for a public opinion poll using geographic or geopolitical restrictions, in this case represented by devices within the outline (Client Device A through D: #30A, #30B, #30C, #30D) with eligible devices marked by a green checkmark (#420) for demonstration and client devices outside of the outline restricted from participating in the poll with this limitation (Client Device E, F and G: #30E, #30F, #30G) with ineligible devices marked by a red X for demonstration (#410).

A logarithm to determine the eligibility of the client device in the public opinion poll with geographic or geopolitical restrictions may be applied. This logarithm would take into account the client setup profile in which was provided the client country, state/province, county, city or other location related data that serve to place the client in a geographic or geopolitical zone without affecting client anonymity, and the device location at the time the public opinion poll is distributed to the population. The device location at the time of the public opinion poll may be provided by geotagging or otherwise interfacing with the device GPS or network location data. Based on the results of the two generic parameters discussed, the system may or may not make the geographically or geopolitically restricted public opinion poll available to said client device.

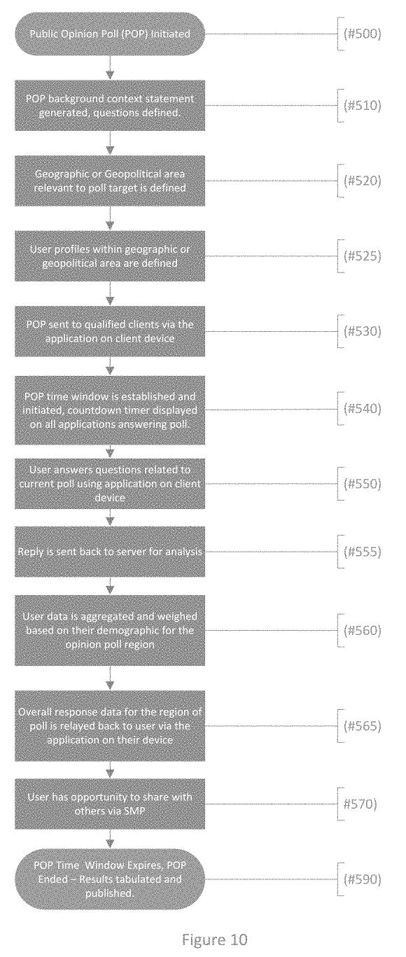

FIG. 10: A process flow representative of the steps undertaken from initiation through expiry of the time limitation for the poll. Flow commences with the initiation of the poll (#500), context data and questions are defined (#510), geographic or geopolitical area is defined (#520), user eligibility is defined and eligible users are identified (#525), Public Opinion Poll (POP) is sent to client devices (#530), public opinion poll time window is established and countdown timer is initiated (#540), user answers poll questions using application (#550), data is returned to server for processing (#555), poll answers are aggregated and calculations made to extrapolate regional response (#560), data is represented graphically and relayed back to the client device for display (#565), response data can be shared among users or the public (#570), public opinion poll is closed when public opinion poll time window runs out (#590) and the results are tabulated and published.

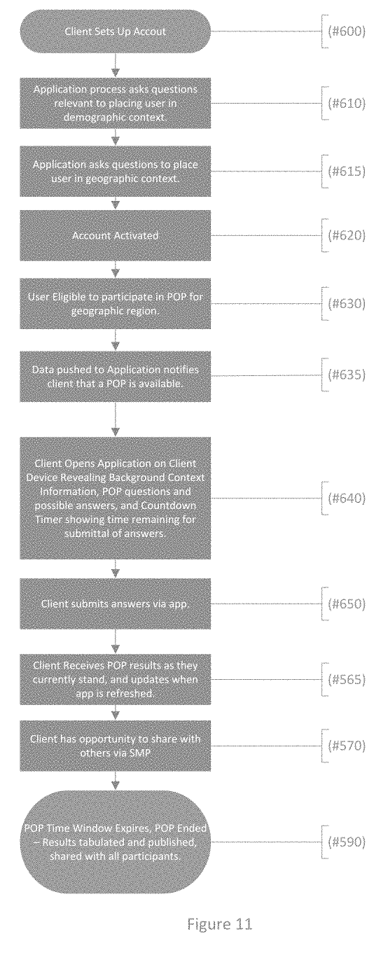

FIG. 11: A process flow representative of the client experience including the account setup phase through to the end of the poll participation process. Flow commences with the setup of the client account in the application (#600), application asks questions to place user in demographic context (#610), application asks questions to place the user in the geographic or geopolitical context (#615), user account is activated (#620), upon creation of a poll as described in FIG. 10, user is selected for polls for the appropriate region (#630), poll questions and context data are displayed on client device in application (#640), answers are submitted via application (#650), results are received back on the user application showing current poll results (#565), user has opportunity to share results (#570), public opinion poll is closed when 48 hour window runs out (#590) and the results are tabulated and published.

The invention claimed is:

1. An apparatus for conducting one or more public opinion polls, over a pre-defined geographical or geopolitical area or zone for which demographic data is known, comprising: a software server resident on a computing device configured to communicate over a network with an application resident on a client device, where the software server is configured to present one or more screens, pages, or data otherwise intended for the application resident on the client device, which the one or more screens, pages, or data are displayed on a display screen of the client device, where centrally pre-determined public opinion poll questions are displayed on the client device, where unlimited numbers of client devices are utilized simultaneously.

2. The apparatus of claim 1, where simple and brief background explanation or context is given for the three poll questions that follow, enabling the respondent to make an informed choice, contextual information is phrased in the common language and simple terms to enable the average user to comprehend the content.

3. The apparatus of claim 1, where no more than three questions are posed at any one time, where all three questions comprising the entirety of the public opinion poll tranche are visible on the device screen at any time, where questions are written in easy to understand syntax suitable for the average population literacy level.

4. The apparatus of claim 1, where no more than three choices for opinion response for each question are provided, under each question, where the three possible responses can be easily associated with each question; where the user can select only the affirmative, no opinion/neutral or negative response, where the three choices are provided in the affirmative, no opinion/neutral or negative sequence only from left to right, or in accordance with the reading orientation of the prevailing language in the region; where the user makes a selection of only one of the three offered choices using software-based buttons or otherwise by speaking into, tapping or swiping on a device screen, or using visual selection; where the choices available are shown as graphics or caricatures that are easily distinguishable as affirmative, no opinion or negative responses by the average user;

5. The apparatus of claim 1, where once all three questions in the public opinion poll have been answered on the application resident on the client device, the data is submitted over a network back to the software server resident on a computing device configured to communicate with an application resident on a client device, where data is analyzed and computed by the server and where calculations are made to place the response in the proper demographic category and extrapolate the responses for the entire polled region, as they are represented at the time of the calculation, called for the purpose of this discussion “result”;

6. The apparatus of claim 1, where result of the public opinion poll is relayed back to the application resident on the client device over a network, and the application is configured to display a new page on the application resident on the client device showing the current result of the poll following the client's submission of the data; where this data is updated when updated data is available or when the application is opened again or refreshed by the client;

7. The apparatus of claim 1, where the results of the opinion poll are easily transferrable through mutual agreement with third party social networking sites for posting on the third party platform the user's selection and public opinion poll data as it is currently tabulated at the time of posting;

8. The apparatus of claim 1, where the posts on other media sites will give the opportunity for others viewing the results to participate in the opinion poll by selecting a link to download the application from available sources, and upon completion of the application process to participate in the same opinion poll and continue the process in perpetuity;

9. The apparatus of claim 1, where the application resident on the software server is configured to receive and interpret geographical or Global Positioning System (GPS) or similar data received from the application resident on the client device to determine if the client device is in the correct geographic or geopolitical space being sampled by the public opinion poll, and combine this information with the user profile provided during the account setup phase, to determine if the user of the application is in the relevant geographic or geopolitical zone relevant to the public opinion poll being answered and eligible to participate in a geographically or geopolitically restricted public opinion poll and to include or exclude this response according to a predetermined method and; where the application resident on the client device is configured to relay the device geographic or Global Positioning System (GPS) or similar geotagging data to the application resident on the software server.
